(19) United States
(12) Patent Application Publication
(10) Pub. No.: US 2016/0147387 A1
(43) Pub. Date: May 26, 2016

(54) METHOD AND APPARATUS FOR DISPLAYING SUMMARIZED DATA

(71) Applicant: SAMSUNG ELECTRONICS CO., LTD., Suwon-si (KR)

(72) Inventors: Yanuar RAHMAN, Jakarta (ID); Omar ABDILLAH, Jakarta (ID); Fajri, Jakarta (ID)

(73) Assignee: SAMSUNG ELECTRONICS CO., LTD., Suwon-si (KR)

(21) Appl. No.: 14/947,780

(22) Filed: Nov. 20, 2015

(30) Foreign Application Priority Data
Nov. 21, 2014 (ID) P00201407282
Oct. 20, 2015 (KR) 10-2015-0146326

(51) Int. Cl. G06F 3/0482; G06F 17/27; H04M 1/725

(52) U.S. Cl. CPC G06F 3/0482; H04M 1/72547; G06F 17/2765

(57) ABSTRACT

A method of operating an electronic apparatus, including displaying an interface associated with a plurality of messages received by the electronic apparatus; displaying summarized data associated with the plurality of messages when a first input is detected at the interface; and displaying the plurality of messages when a second input is detected at the interface.

### CROSS-REFERENCE TO RELATED APPLICATION

This application claims benefit under 35 U.S.C. §119(a) to Indonesian Application Serial No. P00201407282, which was filed in the Indonesian Patent Office on Nov. 21, 2014 and Korean Application Serial No. 10-2015-0146326, which was filed in the Korean Intellectual Property Office on Oct. 20, 2015, the entire content of which is hereby incorporated by reference.

### BACKGROUND

1. Field

The present disclosure relates to a method and an apparatus for displaying summarized data.

2. Description of the Related Art

Online instant messaging has become a trend in the sending of messages that may consist of texts, audio and video. Various applications have been developed to cater the increasing needs of message sending. What's-App, Blackberry Messenger, Kakao Talk, WeChat, Line, etc., are examples of popular instant messaging service applications that have become widely-known and frequently used by users around the world. The majority of such services use internet connections, and the internet fees are only charged for the sending and receiving messages. Due to rapid growth of active users, every day, a user may receive messages in huge quantities. Moreover, unlike traditional short messaging services, this service application enables the user to send long and unlimited messages. As a result, many messages remain unread, especially for group chats that are stored in an application. To facilitate the users in retrieving such unread messages, there is needed a framework of summarizing text for unread messages.

Research on text summarization has been conducted by many researchers. A number of techniques and algorithms have been proposed and published. This condition is obvious in view of fact of enormous textual data, most of which are in digital format. To facilitate textual information processing in fast manner, summarization of such data is necessary to implement.

A method of summarization may be shown for example in in U.S. Patent Office application Ser. No. 11/560,503 of 2011. It is noted that the present disclosure is different and unique. U.S. patent application Ser. No. 11/560,503 relates to the summarization of texts among several users/clients where the summary will be given to new user/client wishing to enter chat group. This summary is to provide information of previous talk/chat to such new user who just joins in the chat.

U.S. Patent Application Pub. No. 2004/0122657 further relates to the techniques of topic-based summarization. It is relevant to the present disclosure, i.e. mechanism to summarize various service platforms.

There is needed a method for processing large information of unread messages into information that can be easily retrieved by just reading the summary. Evaluation systems are further needed, in which the users will evaluate the provided summary and in turn will enable the system to update the existing summarization technique.

There is some research relating to this text summarization techniques. The first is by Carbonell, J., and Goldstein, J. “The Use of MMR, diversity-based reranking for reordering documents and producing summaries”, SIGIR 1998, pp. 335-336. ACM, New York, 1998 shows formula to re-rank sentences based on the similarities between sentences and whole documents.

The second publication is by Liu, D., Liu, Z., and Dong, Q “A dependency grammar and WordNet based sentence similarity measure”. Journal of Computational Information Systems 8:3 1027-1035, 2012, working out on the formula to calculate the similarities of semantics of two words, which is also known as words-relationship-Tree.

Other work was prepared by Berry, M. W., & kogan, J. Text Mining: Applications and Theory, revealing Latent Dirichlet Allocation (LDA) that defined generative probabilistic model of corpus/document aimed to set words expressing the topics of document. The basic idea was that documents are considered as random mix of hidden topics, where each topic was characterized with word distribution. On the other side, the existing approach to extract keywords of unstructured documents like chat documents is that of Rapid Keyword Extraction (RAKE). As to the present disclosure, the summary of unread messages will be automatically validated and prepared for all users in online instant messaging.

None of the foregoing references or their combinations provides an interface graph on how to display a summary.

### SUMMARY

A scheme of summarizing unstructured texts used for unread messages in online instant messaging services is provided. The idea is relatively promising since active users of online instant messaging services grow rapidly.

According to an aspect of an exemplary embodiment, a method of operating an electronic apparatus includes displaying an interface associated with a plurality of messages received by the electronic apparatus; displaying summarized data associated with the plurality of messages when a first input is detected at the interface; and displaying the plurality of messages when a second input is detected at the interface.

The method may further include: receiving the plurality of messages from a server communicating with the electronic apparatus; transmitting a request for the summarized data to the server; and receiving the summarized data from the server.

The request for the summarized data may be transmitted when a time difference between a first time at which a user confirmed a message and a second time at which the interface is displayed is larger than a threshold value.

The method may further include: receiving at least one other message after receiving the summarized data; displaying the interface; displaying the summarized data and the at least one other message when a third input is detected at the interface; and displaying the plurality of messages and the at least one other message when a fourth input is detected at the interface.

The method may further include: transmitting a request for the summarized data to the server when the interface is displayed.

The method may further include: transmitting feedback data associated with at least one from among the first input and the second input to the server.

The summarized data may be generated based on at least one from among data included in the plurality of messages and the feedback data by the server.

According to another aspect of an exemplary embodiment, a method of operating a server may include transmitting a plurality of messages to an electronic apparatus; receiving a request for summarized data associated with the plurality of messages from the electronic apparatus; and transmitting the summarized data to the electronic apparatus.

The method may further include: determining whether the summarized data is capable of being generated based on the plurality of messages; clustering the plurality of messages into a plurality of clusters when the summarized data is capable of being generated; and generating the summarized data by summarizing the plurality of clusters.

The method may further include: receiving feedback data associated with the summarized data from the electronic apparatus; and evaluating the summarized data based on the feedback data.

The summarized data may be generated based on at least one from among data included in the messages and the feedback data by the server.

The method may further include: generating the summarized data associated with the messages by comparing the accuracy of the summarized data and the accuracy of previous summarized data based on the feedback data.

According to another aspect of an exemplary embodiment, an electronic apparatus includes a display configured to display an interface associated with a plurality of messages received by the electronic apparatus, to display summarized data associated with the plurality of messages when a first input is detected at the interface; and to display the plurality of messages when a second input is detected at the interface.

The electronic apparatus may further include: a transceiver configured to receive the messages from a server connected to the electronic apparatus, to transmit a request for the summarized data to the server, and to receive the summarized data from the server.

The request for the summarized data may be transmitted when a time difference between a first time at which a user confirms a message and a second time at which the interface is displayed is larger than a threshold value.

The transceiver may be configured to receive at least one other message after receiving the summarized data, and the display may be further configured to display the interface; to display the summarized data and the at least one other message when a third input is detected at the interface; and to display the messages and the at least one other message when a fourth input is detected at the interface.

The transceiver may be further configured to transmit a request for the summarized data to the server when the interface is displayed.

The transceiver may be further configured to transmit feedback data associated with at least one from among the first input and the second input to the server.

The summarized data may be generated based on at least one from among data included in the plurality of messages and the feedback data by the server.

According to another aspect of an exemplary embodiment, a server apparatus includes a transceiver configured transmit a plurality of messages to an electronic apparatus, to receive a request for summarized data associated with the plurality of messages from the electronic apparatus; and to transmit the summarized data to the electronic apparatus.

The server apparatus may further include: a controller configured to determine whether the summarized data is capable of being generated based on the plurality of messages; to cluster the plurality of messages into a plurality of clusters when the summarized data is capable of being generated; and to generate the summarized data by summarizing the plurality of clusters.

The transceiver may be further configured to receive feedback data associated with the summarized data from the electronic apparatus, and the controller may be further configured to evaluate the summarized data based on the feedback data.

The summarized data may be generated based on at least one from among data included in the plurality of messages and the feedback data by the server.

The controller may be further configured to generate the summarized data by comparing the accuracy of the summarized data with the accuracy of previous summarized data based on the feedback data.

According to another aspect of an exemplary embodiment, a method of controlling an electronic apparatus includes receiving an input from a user at a first time; receiving a plurality of messages from a server at a second time; determining a time difference between the first time and the second time; if the time difference is greater than a predetermined threshold, requesting from the server summarized data associated with the plurality of messages; and displaying at least one of the summarized data or the plurality of messages to the user.

### BRIEF DESCRIPTION OF FIGURES

To understand the present disclosure and to see how it can be implemented in practice, see the following description based on attached figures.

To understand the present disclosure and to see how it can be implemented in practice, explain the following description based on attached figures.

FIG. 1 illustrates a configuration of a summarization system according to an exemplary embodiment of the present disclosure.

FIG. 2 illustrates a configuration of a client apparatus according to an exemplary embodiment of the present disclosure.

FIG. 3 illustrates a configuration of a server apparatus according to an exemplary embodiment of the present disclosure.

FIG. 4 illustrates a flow chart indicating operation of a server when the server receives a new message from a first client apparatus according to an exemplary embodiment of the present disclosure.

FIG. 5 illustrates a flow chart indicating operation of a server when the server receives summarized data from a second client apparatus according to an exemplary embodiment of the present disclosure.

FIG. 6 illustrates a summarization procedure according to an exemplary embodiment of the present disclosure.

FIG. 7 illustrates a flow chart of server operation when a server receives a summarization request according to an exemplary embodiment of the present disclosure.

FIG. 8 illustrates a flow chart of operation in a client apparatus when the client apparatus receives an unread message according to an exemplary embodiment of the present disclosure.

FIG. 9 illustrates a flow chart of operation in a client apparatus when a user opens an unread message according to an exemplary embodiment of the present disclosure.

FIG. 10 illustrates a flow chart of operation in a server for evaluating summarization of unread messages according to an exemplary embodiment of the present disclosure.

FIG. 11 illustrates a user interface in a client apparatus according to an exemplary embodiment of the present disclosure.

FIG. 12 illustrates a flow chart of displaying of a user interface in a client apparatus according to an exemplary embodiment of the present disclosure.

FIG. 13 illustrates a flow chart of operation in a client apparatus for displaying a user interface in a client apparatus according to another exemplary embodiment of the present disclosure.

FIG. 14 illustrates a user interface in a client device according to another exemplary embodiment of the present disclosure.

FIG. 15 illustrates a flow chart of displaying of a user interface in a client apparatus according to another exemplary embodiment of the present disclosure.

FIG. 16 illustrates a flow chart for keyword extraction according to an exemplary embodiment of the present disclosure.

FIG. 17 illustrates a flow chart of operation in a server apparatus for transceiving a signal according to an exemplary embodiment of the present disclosure.

FIG. 18 illustrates a flow chart of operation in a client apparatus for transceiving a signal according to an exemplary embodiment of the present disclosure.

### DETAILED DESCRIPTION

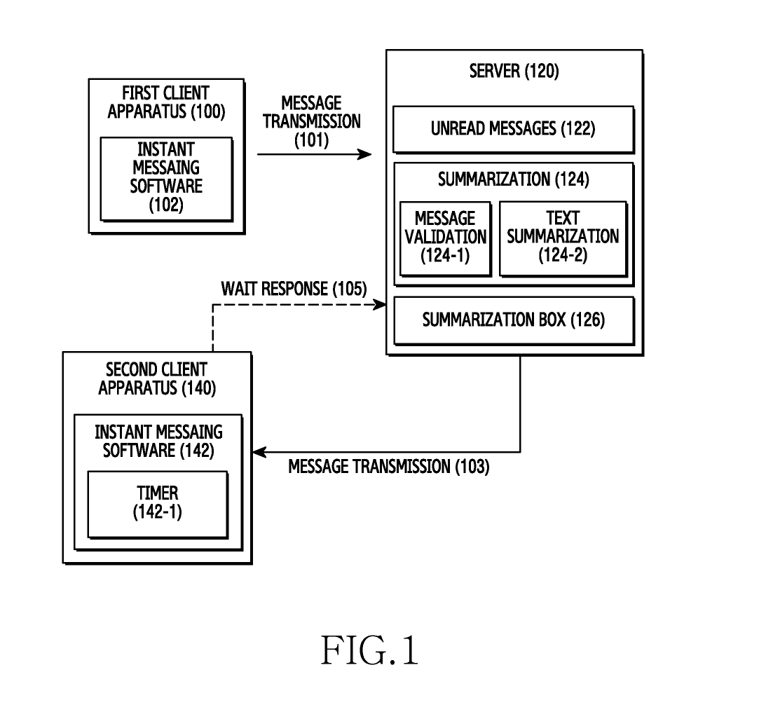

FIG. 1 illustrates a configuration of a summarization system according to an exemplary embodiment of the present disclosure. A first client is shown as a sender to “persons” represented by a second client. The figure illustrates an example in which the first client sends message to the second client. The message may consist of personal message or message for group. Then, the server may forward the message and wait for a response status (ack) from the second client. As long as the receiver (the second client) has not yet read the message, the second client service may run the timer. This timer may be used to trigger summarization system to summarize unread message at certain threshold.

There are two stages in summarization under the present disclosure; message validation and text summarization. Message validation is used to recommend to the summarization system whether an unread message can be summarized or not. The summarization may take place if the output is “yes”. The produced summary may be stored in summary box and may be updated based on request. The second client may automatically receive summaries when the second client opens the message. The first client can be a first client apparatus 100. The second client can be a second client apparatus 140.

Still referring to FIG. 1, at step 101, a first client apparatus 100 transmits a message to a server 120. The server 120 stores messages received from the first client apparatus 100. In step 103, the server 120 forwards the messages received from the first client apparatus to the second client apparatus 140. In step 105, the server 120 waits for a response (for example, an acknowledgement) from the second client apparatus 140. The first client apparatus 100 is an apparatus of a sender side for the second client apparatus 140. For example, the first client apparatus 100 and the second client apparatus 140 can be a terminal apparatus for transceiving (which may refer, for example, to receiving and transmitting) data for a specific service. The first client apparatus can be a first client. The first client can be, for example, a human.

Referring to FIG. 1, the first client apparatus 100 includes instant messaging software 102. The server 120 stores unread messages 122 and performs message validation 124-1 and text summarization 124-2 in summarization 124. The message validation 124-1 may be a learning-based model designed by learning a plurality of chatting documents associated with characteristics of a document. The message validation 124-1 is used to advise a summary system, which determines whether summarization of unread messages should be performed by applying a binary classification concept.

For example, if the second client apparatus 140 outputs “yes”, the server 120 summarizes the unread messages. In addition, the server 120 updates and stores messages summarized in a summarization box 126.

The unread messages 122 are messages which are not confirmed in the second client apparatus 140 and which are not read by a second client of the second client apparatus 140. The second client apparatus 140 runs a timer 142-1 until the messages are read in the second client apparatus 140. The timer 142-1 is used for summarizing unread messages in a specific threshold value by triggering the summarization system. When the message is opened a second client apparatus 140 automatically receives summarized information. The summarization system may provide an evaluation unit for evaluating and updating text summarization in order to form a better chatting summarization model than an existing chatting summarization model in designing chat summary. For example, the first client apparatus 100 can be indicated as other electronic apparatus. The second client apparatus 140 can be indicated as an electronic apparatus.

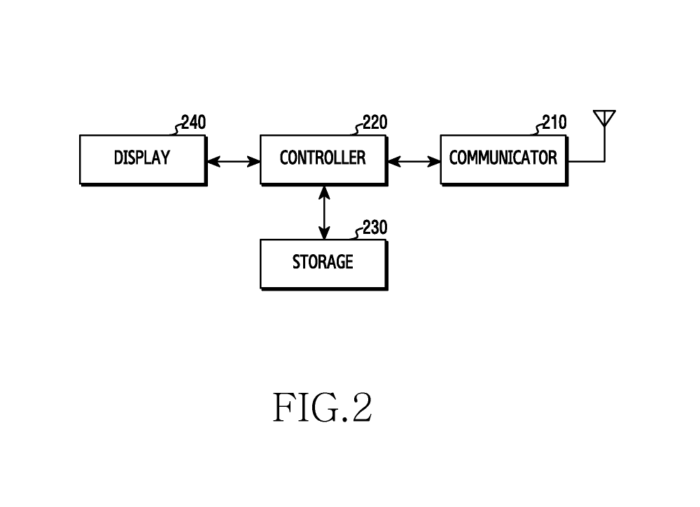

FIG. 2 illustrates an example of a configuration of a client apparatus according to an exemplary embodiment. Terms such as ‘˜unit’ and ‘˜er’ represent a unit for processing at least one function or operation, and can be implemented using hardware, software, or a combination of hardware and software.

Referring to FIG. 2, the example client apparatus includes a communicator 210, a controller 220, a storage 230, and a display 240.

The communicator 210 performs functions for transceiving signals via a wireless channel. For example, the communicator 210 performs a conversion function between a baseband signal and a bit stream in accordance with a physical layer standard of a system. For example, in data transmission, the communicator 210 generates demodulation symbols by modifying and encoding transmission bit stream. Further, in data reception, the communicator 210 restores a reception bit stream through decoding and demodulation in the baseband signal. Further, the communicator 210 transmits an RF band signal through an antenna after up-converting the baseband signal into the RF band signal. The communicator 210 converts the RF band signal received through the antenna into the baseband signal. For example, the communicator 210 includes a transmission filter, a reception filter, an amplifier, a mixer, an oscillator, digital to analog converter (DAC), analog to digital converter (ADC), and the like. In some exemplary embodiments, communicator 210 may be a transmitter, a receiver, and a transceiver. According to an exemplary embodiment of the present disclosure, the communicator 210 receives messages from a server apparatus, receives summarized data associated with the messages, transmits a request for the summarized data to the server apparatus, and transmits feedback data for a first input and a second input.

The controller 220 controls the operations of the client apparatus. For example, the controller 220 transmits and receives signals through the communicator 210. Further, the controller 220 reads and records data in the storage 230. To achieve this, the controller 220 can include at least one processor. For example, the controller 220 may include a communication processor (CP) to perform a control for communication, and an application processor (AP) to control an upper layer such as an application program and the like. The controller 220 controls the operation of a timer. According to an exemplary embodiment of the present disclosure, the controller 220 controls feedback for a selection result of a user on a selection window which selects whether summarized messages are displayed. The controller 220 detects a first input and a second input for an interface. The controller 220 displays summarized data associated with the messages by controlling the display 240 when the controller 220 detects the first input. The controller 220 displays messages when the controller 220 detects the second input. The messages are displayed based on reception time orders. The messages are displayed based on the time set by a user.

The storage 230 stores a basic program for operation of the client apparatus, an application program, setting data, software, and the like such as data. According to an exemplary embodiment of the present disclosure, the storage 230 can store instant messaging software. The storage 230 provides stored data according to the request of the controller 230. For example, the storage 230 may be a memory apparatus.

The display 240 displays a user interface (UI) of the client apparatus. For example, the user interface may be an external display such as an external monitor, a panel, a TV screen, a projector, or a Bluetooth transceiver, a universal serial bus (USB), a high definition multimedia interface (HDMI), a digital video interactive (DVI) port, and a virtual iris display. The user interface can be indicated as an interface. The user interface is displayed as a selection window in which the user determines a specific selection.

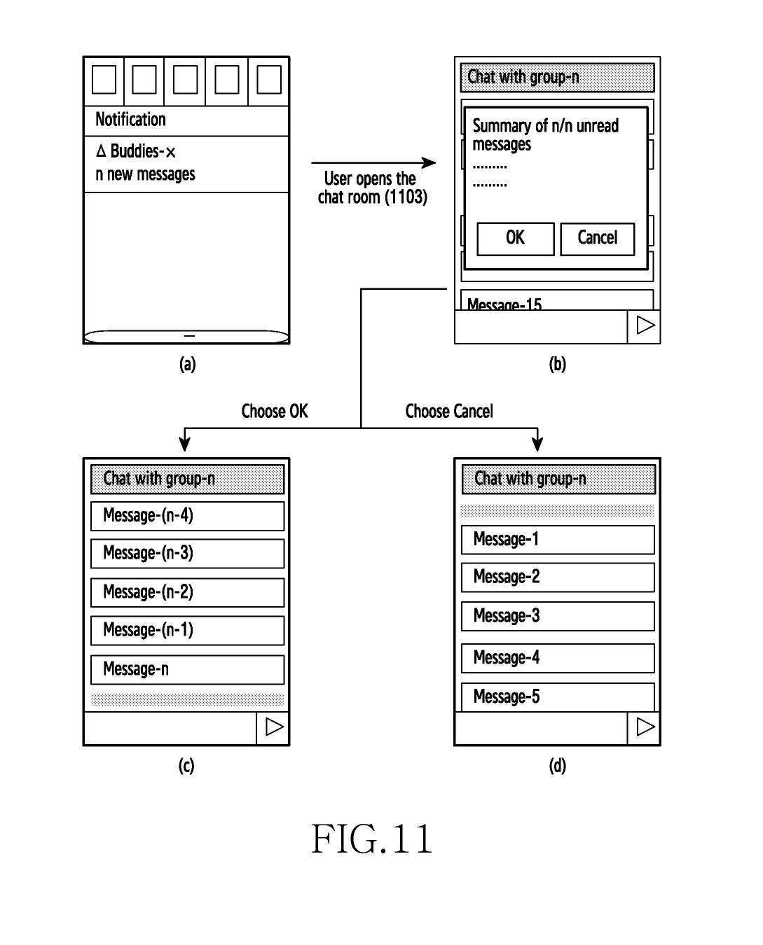

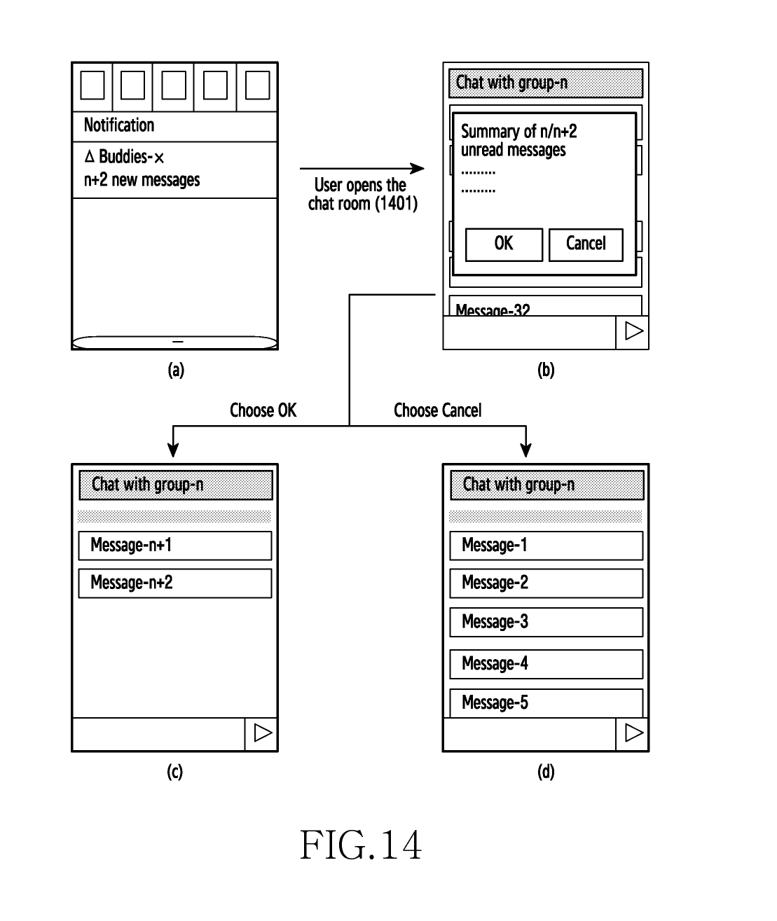

For example, the display 240 may display a user interface as demonstrated in FIG. 11 and FIG. 14.

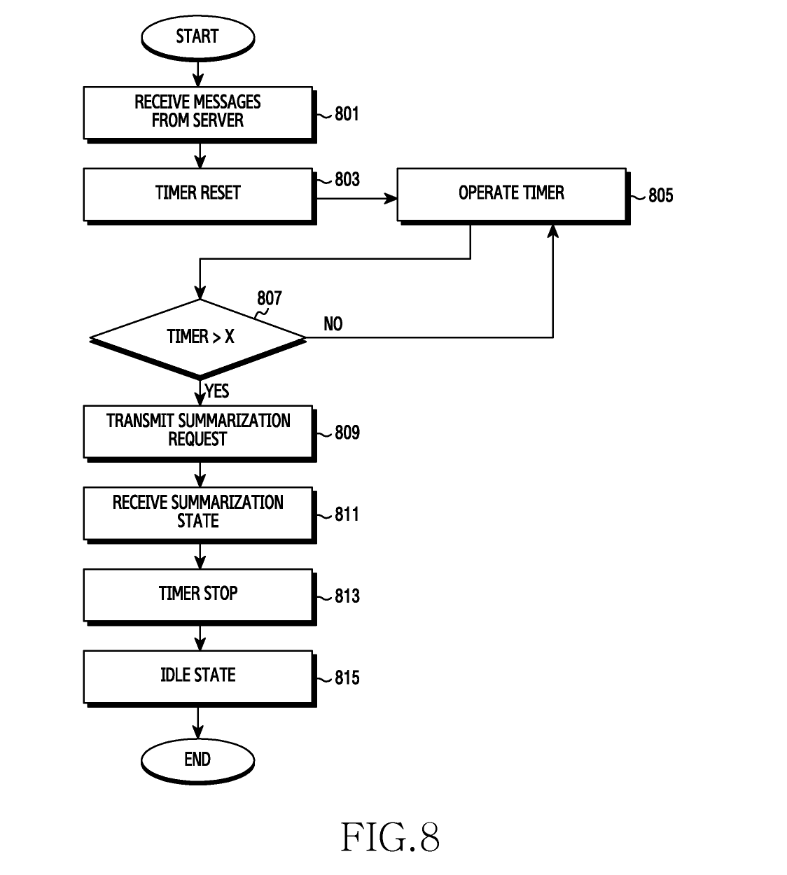

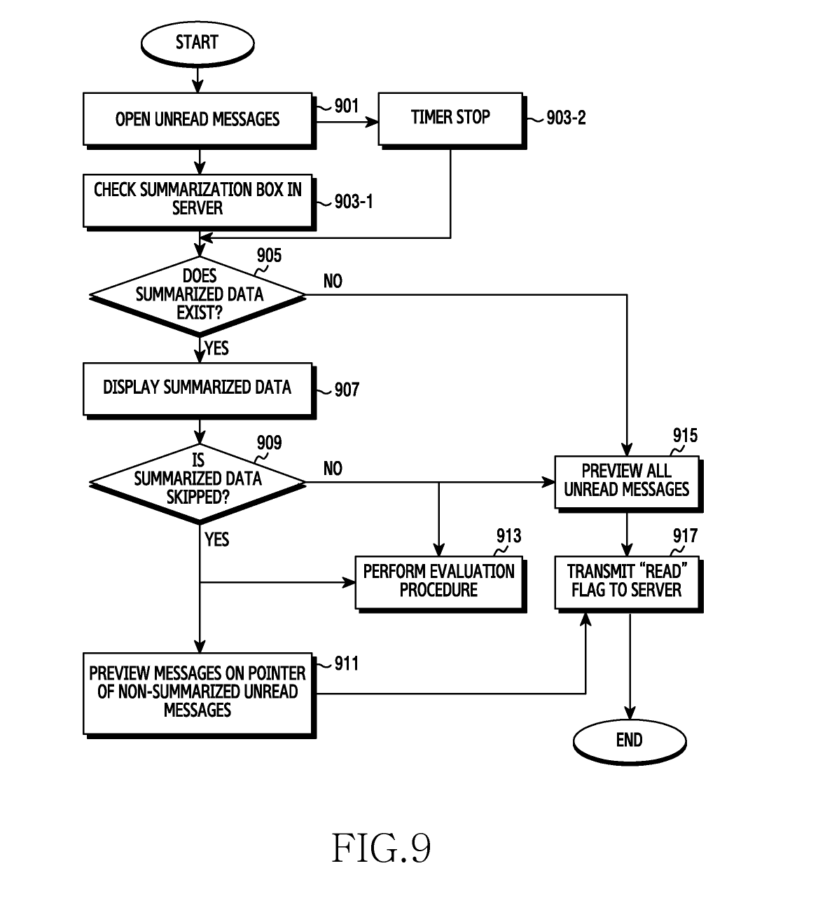

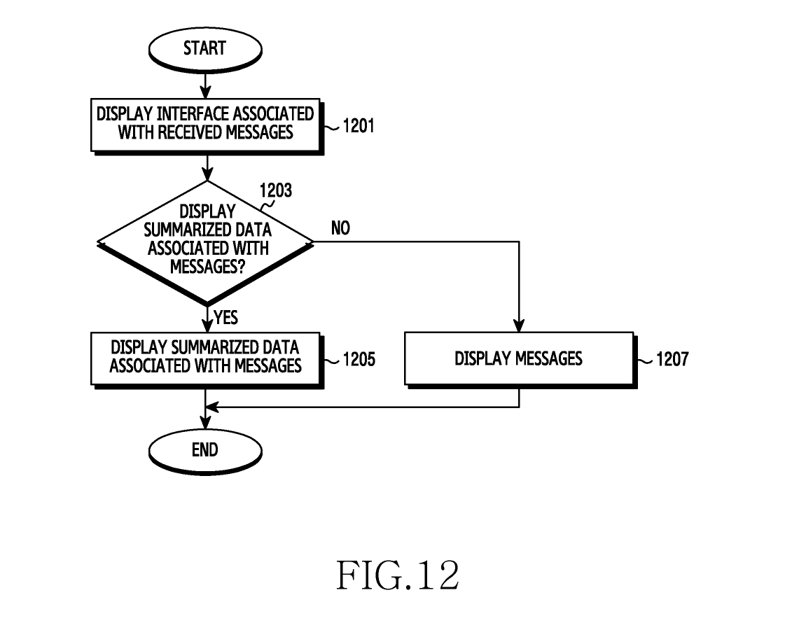

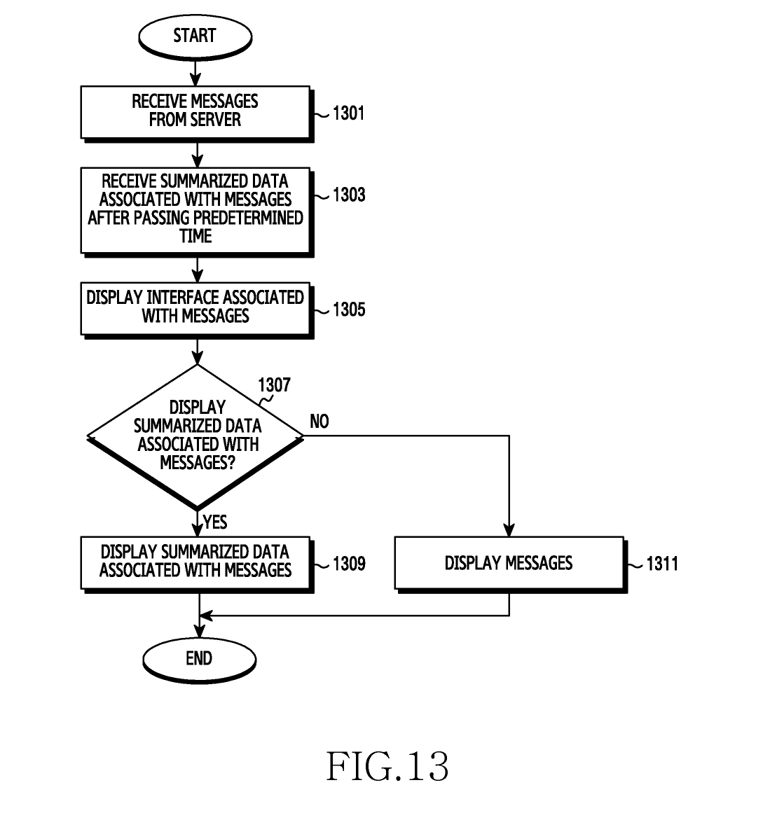

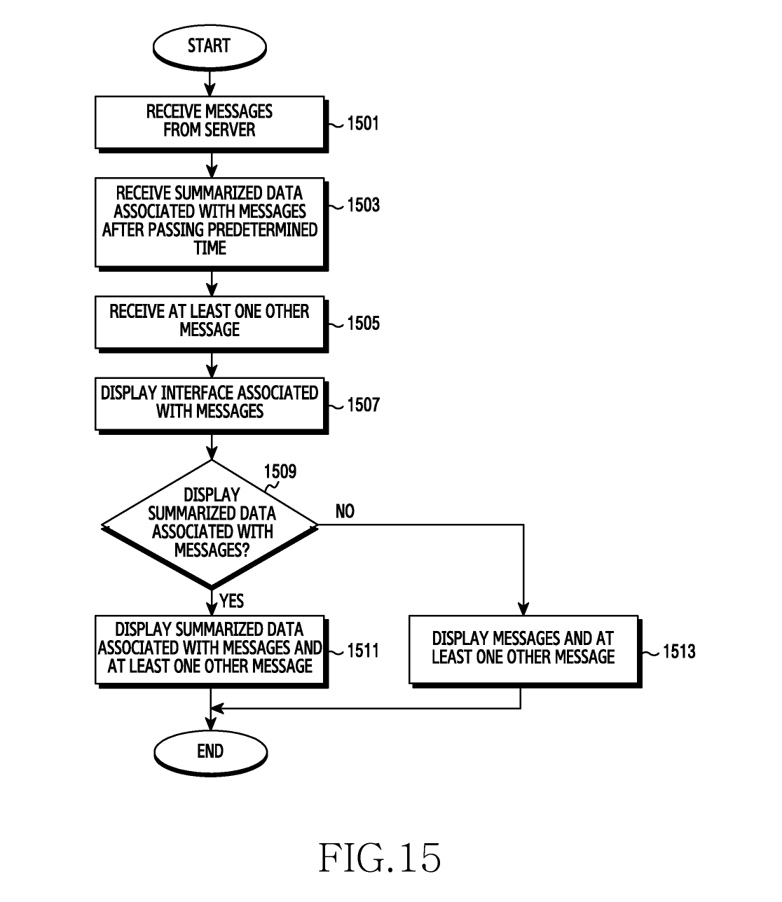

For example, the controller 220 may control procedures illustrated in FIG. 8, FIG. 9, FIG. 11, FIG. 12, FIG. 13, FIG. 14, FIG. 15, and the like.

For example, the client apparatus is indicated as an electronic apparatus for receiving a message, an electronic apparatus for transmitting a message, an electronic apparatus for displaying a user interface, and a terminal apparatus.

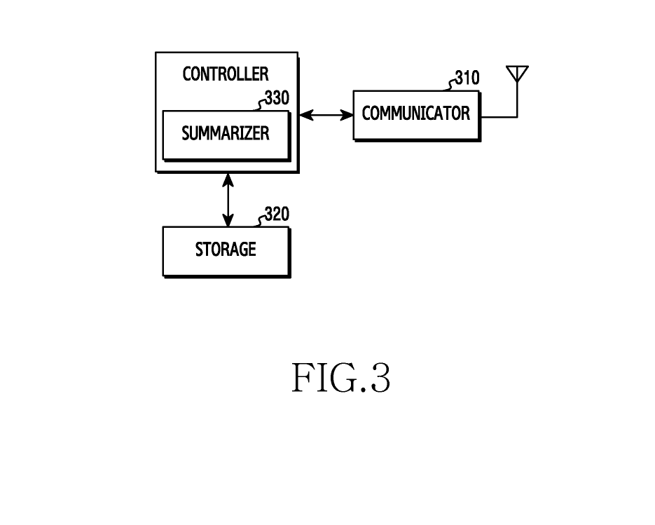

FIG. 3 illustrates a configuration of a server apparatus according to an exemplary embodiment of the present disclosure. Terms such as ‘˜unit’ and ‘˜er’ represent a unit for processing at least one function or operation, and can be implemented using hardware, software, or a combination of hardware and software.

Referring to FIG. 3, the example server apparatus includes a communicator 310, a storage 320, and a controller 330.

The communicator 310 performs functions for transceiving signals via a wireless channel. For example, the communicator 310 performs a conversion function between a baseband signal and a bit stream in accordance with a physical layer standard of a system. For example, in data transmission, the communicator 310 generates demodulation symbols by modifying and encoding transmission bit stream. Further, in data reception, the communicator 310 restores a reception bit stream through decoding and demodulation in the baseband signal. Further, the communicator 310 transmits an RF band signal through an antenna after up-converting the baseband signal into the RF band signal. The communicator 310 converts the RF band signal received through the antenna into the baseband signal. For example, the communicator 310 includes a transmission filter, a reception filter, an amplifier, a mixer, an oscillator, DAC(digital to analog converter), ADC(analog to digital converter), and the like. In some exemplary embodiments, communicator 310 may be be a transmitter, a receiver, and a transceiver. According to an exemplary embodiment of the present disclosure, the communicator 310 receives feedback for the display of the summarized messages determined based on the selection of a user from the client apparatus. The communicator 310 receives messages from other electronic apparatuses, transmits messages to an electronic apparatus, receives a request for the summarized data associated with the messages from the electronic apparatus, and transmits the summarized data to the electronic apparatus. According to an exemplary embodiment of the present disclosure, the communicator 310 receives feedback data associated with the display of the summarized data from the electronic apparatus.

The storage 320 stores a basic program for operation of the client apparatus, an application program, setting data, software, and the like such as data. Messages may include personal messages and group messages. The messages are classified as read messages and unread messages.

According to an exemplary embodiment of the present disclosure, the storage 320 stores unread messages and includes a summarization box 126 for storing summarized messages. The storage 320 provides data such as the summarized messages and the unread messages according to the control of the controller 330. The messages are stored as the summarized data associated with the messages.

The controller 330 controls the operations of the client apparatus. For example, the controller 330 transmits and receives signals through the communicator 310. Further, the controller 330 reads and records data in the storage 330. To achieve this, the controller 330 can include at least one processor. For example, the controller 330 includes a communication processor (CP) to perform a control for communication and an application processor (AP) to control an upper layer such as an application program and the like.

According to an exemplary embodiment of the present disclosure, the controller 330 includes a summarizer 332. The summarizer 332 confirms unread messages, determines whether the unread messages are summarized, and summarizes the text within the unread messages.

According to an exemplary embodiment of the present disclosure, the controller 330 generates the summarized data associated with the messages. The controller 330 evaluates the summarized data based on the feedback data.

According to an exemplary embodiment of the present disclosure, the controller 330 updates the summarizer 332 based on the user feedback received through the communicator 310.

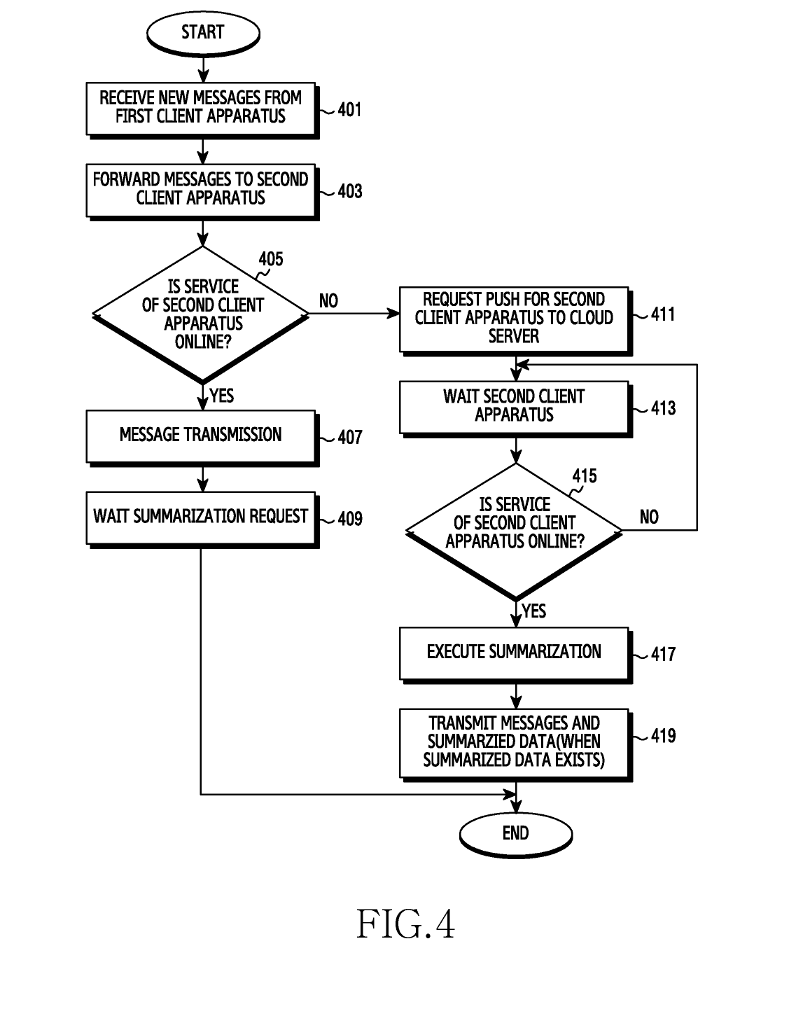

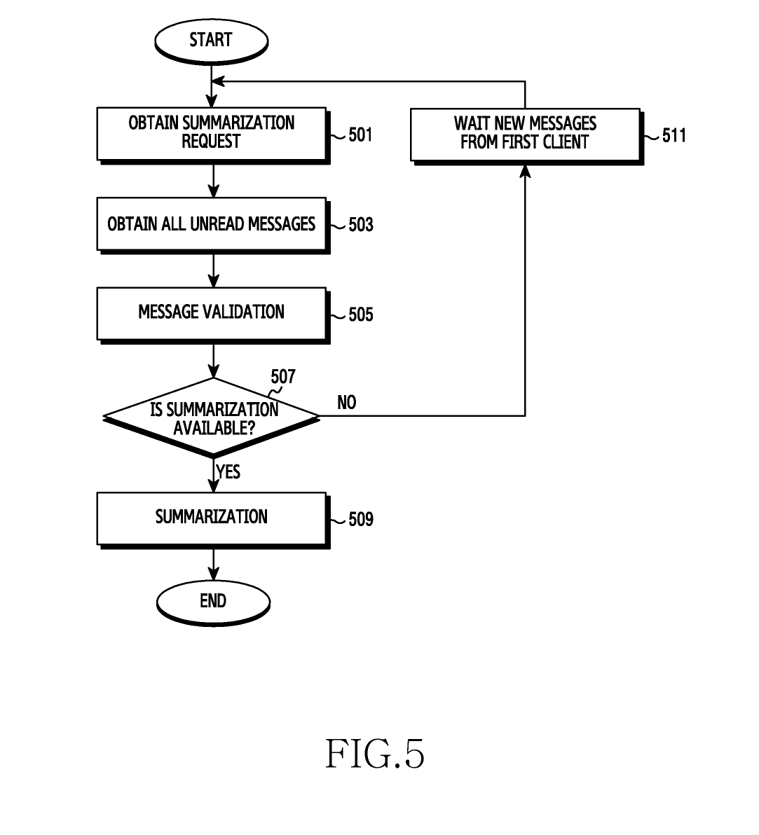

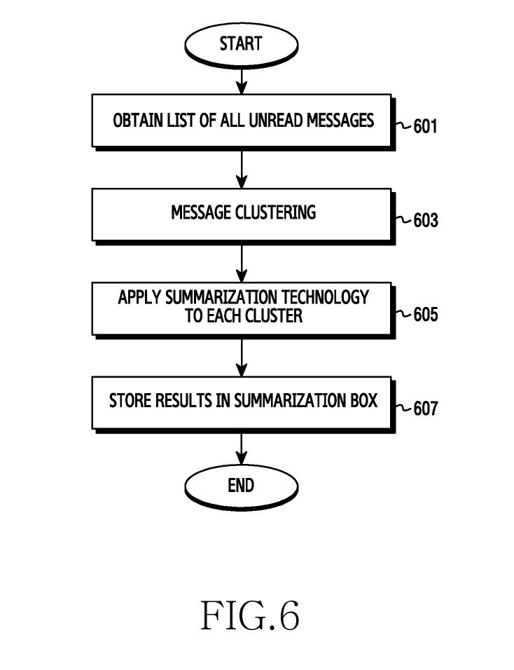

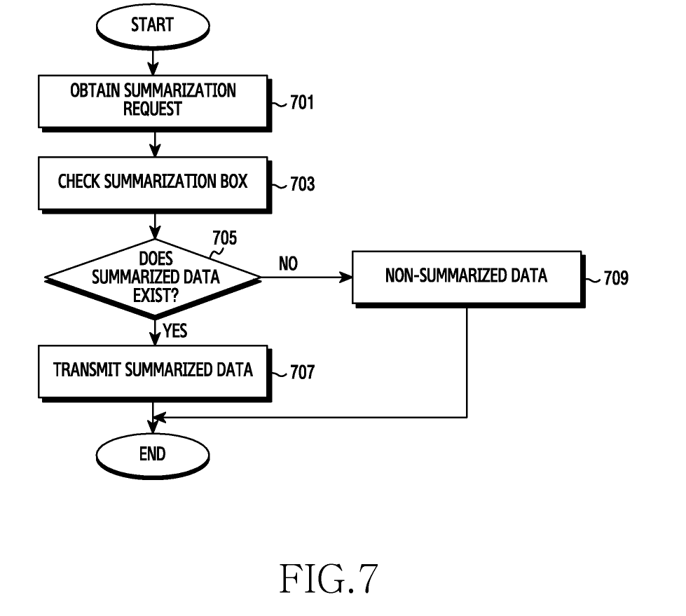

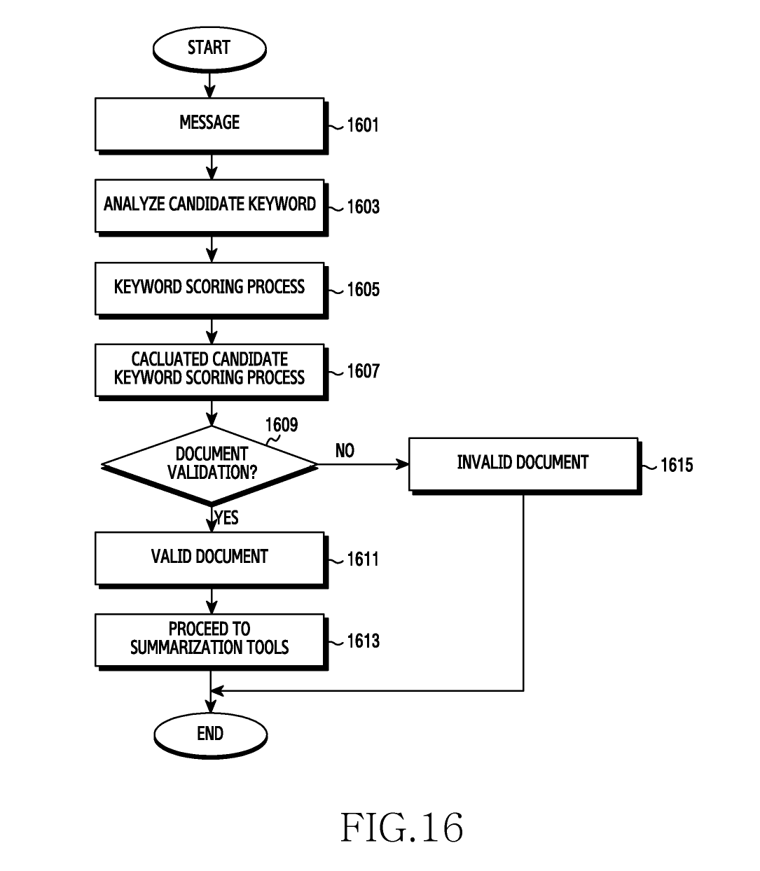

For example, the controller 330 may control procedures illustrated on FIG. 4, FIG. 5, FIG. 6, FIG. 7, FIG. 16, and the like.

FIG. 4 illustrates a flow chart indicating an example operation of a server when the server receives a new message from a first client apparatus according to an exemplary embodiment of the present disclosure. When the first client sends message, server may forward and wait for a response status (ack) of the second client. The second client service may be in online or offline status. In an online status, the server may forward the message and wait for a request for summarization, whereas if the second client service is in an offline status, the server may order a cloud server to push to the second client service. The message may be sent if the second client status changes to online. In this case, the summarization may automatically run. The message and summary (if any) may be sent.

Referring to FIG. 4, in step 401, a server receives a message from a first client apparatus. The server may receive a plurality of messages from the first client apparatus or may receive one message from the first client apparatus. Herein, the first client apparatus is an electronic apparatus controlled by a first client.

In step 403, the server forwards at least one message received from the first client apparatus to a second client apparatus. The second client apparatus is an electronic apparatus controlled by a second client.

In step 405, the server receives a response from the second client by waiting for the response from the second client apparatus. Herein, the response from the second client apparatus indicates a state of the second client apparatus. The state of the second client apparatus can be an online state or an offline state. For example, the response from the second client apparatus can be acknowledge (ACK) or non-acknowledge (NACK).

When the service state of the second client apparatus is the online state, the server executes a step 407 and transmits the messages and waits for a summarization request in step 409.

Otherwise, when a service state of the second client apparatus is the off-line state, in step 411, the server requests a push of a service state in the second client apparatus to a cloud server.

In step 413, the server waits for a response from the second client apparatus. When the state of the second client apparatus has not responded to the push from the cloud server in step 415 and the state of the second client apparatus remains in the off-line state, the server returns to the step 413.

In step 415, when the state of the second client apparatus is turned into the online state, the server automatically performs summarization in the step 417. The server transmits messages and summarization to the second client apparatus when the messages and the summarization exist in the step 419.

FIG. 5 illustrates a flow chart indicating an example operation of a server when the server receives summarized data from a second client apparatus according to an exemplary embodiment of the present disclosure. The summarization may be made automatically based on the request of client, which is triggered by timer. The server may collect unread messages and validate the messages to verify whether such messages can be summarized or not. The summarization may take place if the output of validation system is “yes”. Otherwise, the server may enter a waiting phase awaiting new messages from the first client.

Referring to FIG. 5, in step 501, the server obtains a summarization request. The summarization is automatically executed according to the request of the client and is operated by the timer. In step 503, the server obtains all unread messages. In step 501, the server confirms or validates the messages. In step 507, the server determines whether the confirmed messages are summarized. In step 509, the server summarizes the confirmed messages when the server can summarize the confirmed messages. Otherwise, in step 511, the server waits receiving a new message from the first client apparatus when the server cannot summarize the confirmed messages.

FIG. 6 illustrates an example summarization procedure according to an exemplary embodiment of the present disclosure. A clustering method may be carried out based on time and content features extracted from unread messages. A summary may be made for each cluster. The results are stored in server memory and may be sent when the second client opens unread messages.

Referring to FIG. 6, in step 601, a server obtains a list of all unread messages. In step 603, the server performs clustering of the messages based on a time feature and content extracted from the messages. In step 605, the server applies a summarization technology to each cluster. In step 607, the server stores a summarization result in a summarization box. For example, the summarization box may be a memory apparatus to store summarized data. The server transmits the summarized data to the second client apparatus when a user opens the unread messages in the second client apparatus.

FIG. 7 illustrates a flow chart of an example server operation when a server receives a summarization request according to an exemplary embodiment of the present disclosure. When the second client opens unread messages, the second client service may automatically ask for a summary from the server. The server then checks summary box and sends the summary if any.

Referring to FIG. 7, in step 701, a server receives a summarization request from a second client apparatus. For example, the server automatically receives the summarization request from the second client apparatus by enabling the second client apparatus to automatically request summarization to the server when the second client apparatus opens the unread messages.

In step 703, the server checks a summarization box. The server determines whether the summarized data is stored in the summarization box by checking the summarization box. The summarized data indicates summarized data including the summarization of the unread messages.

In step 705, the server checks the summarized data in the summarization box, in step 707, the server transmits the summarized data to the second client apparatus. In step 705, if the server cannot check the summarized data in the summarization box, or if no summarized data exists, the server transmits non-summarized data. For example, the non-summarized data may be messages which are not summarized. For example, the non-summarized data can be unread messages. Further, transmitting the non-summarized data means that the summarized data is not transmitted.

FIG. 8 illustrates a flow chart of an example operation in a client apparatus when the client apparatus receives an unread message according to an exemplary embodiment of the present disclosure. First, the service may reset and run a timer. If the timer reaches its threshold, the second client service may send summarization request to server. The second client may receive summarization status from server, and the timer may automatically stop.

FIG. 8 illustrates an example procedure to request summarization of unread messages and to receive the unread messages from a server. A second client apparatus can be a receiver.

Referring to FIG. 8, in step 801, the second client apparatus receives messages from the server. In step 803, the second client apparatus resets a timer. In step 805, the second client apparatus executes the timer. In step 807, the second client apparatus executes the timer again, by returning to step 805 when a time is smaller than a threshold X. When the time is larger than or equal to the threshold value X in the step 807, in step 809, the second client apparatus transmits a summarization request to the server. In step 811, the second client apparatus receives a summarization state from the server. In step 813, the second client apparatus stops the timer. In step 815, a state of the second client apparatus is to be an idle state.

FIG. 9 illustrates a flow chart of operation in a client apparatus when a user opens an unread message according to an exemplary embodiment of the present disclosure. When the user opens the service and selects message, online instant messaging may immediately and automatically check a summary box in the server. If there exists a summary, such summary may be shown in client's application. Otherwise, the application may only display unread messages in the case that there is no summary in the server. A “read” flag may be sent to update the status of messages. It is worthwhile to note that a summary may be displayed based on the last summary. Thus, in some exemplary embodiments not all unread messages have been summarized when the client opens such messages. After displaying the summary, a pointer of unread messages may be given based on unread messages that have not been summarized.

FIG. 9 illustrates an example operation of a second client apparatus when a second client opens at least one unread message. The second client may use the second client apparatus.

Referring to FIG. 9, in step 901, the second client apparatus recognizes the opening of the unread message of the second client. In step 903-1, the second client apparatus checks the summarization box of a server. In step 903-2, the second client apparatus stops a timer. For example, when the second client executes a chat room service in the second client apparatus, the second client apparatus can check the summarization box in the server automatically through a function of online instant messaging software. For example, the chat room service is an application operated in the second client apparatus.

Step 905, the second client apparatus checks whether summarized data exists in the summarization box of the server. The summarized data may be unread messages summarized by the server. When the summarized data exists in the summarization box of the server according to a check result, the second client apparatus displays the summarized data on a display in step 907.

In step 909, the second client apparatus displays a window, which asks whether the summarized messages should be skipped, on the display. A user can determine whether the messages are to be displayed through the window which asks whether the summarized messages should be skipped. For example, a window which asks whether the summarized messages should be skipped and which is displayed on the display of the second client apparatus includes “ok” and “cancel”. Skipping of the summarized messages may mean, for example, that the summarized messages are not displayed, or that the messages which are not summarized, are displayed. When the user selects to skip the summarized messages, in step 911 the second client apparatus displays messages which are not summarized on the display and displays a screen in which a pointer is located on the unread messages. In step 917, the second client apparatus transmits a “read” flag to the server in order to update a message state.

In step 905, when summarized data does not exist in a summarization box of a server according to a check result of the summarization box in the server by the second client apparatus, in step 915, the second client apparatus displays all unread messages. In step 917, the second client apparatus transmits a “read” flag to the server. Herein, a “read” flag is transmitted to update the state of the messages.

In step 909, the second client apparatus displays a window, which asks whether the summarized messages should be skipped, on the display. The window is selected by the user. In the step 913, evaluation for the summarized messages is performed based on the selection of the user. The evaluation for the summarized messages is performed to perform suitable message summarization. Herein, the selection of the user is received from the second client apparatus to the server.

The summarization has a worthy of a note that the summarization is displayed with respect to final summarization. The final summarization indicates that all unread messages are not summarized when the client opens the unread messages.

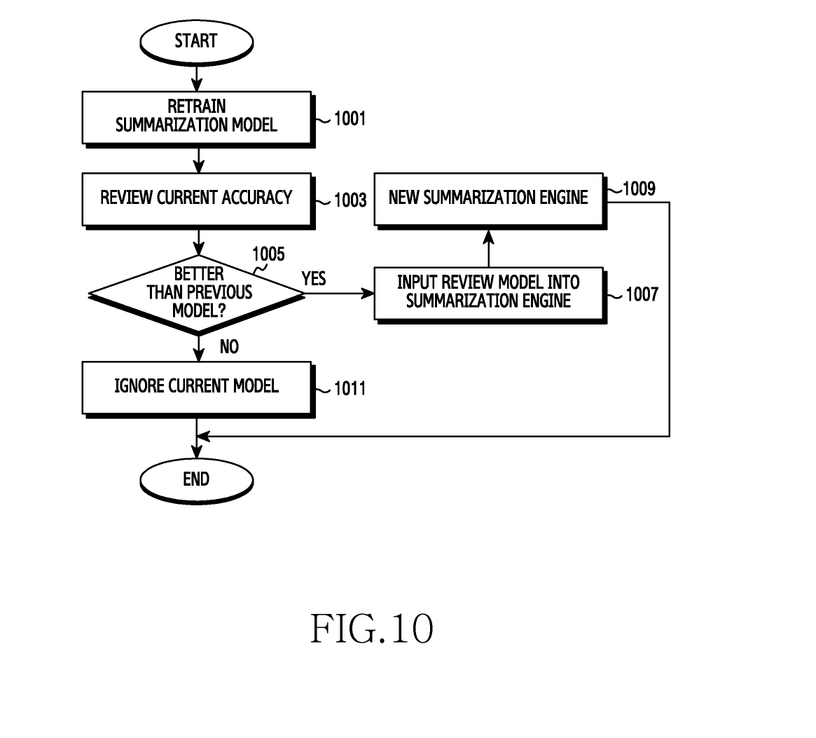

FIG. 10 illustrates an example flow chart of operation in a server for evaluating summarization of unread messages according to an exemplary embodiment of the present disclosure. FIG. 10 illustrates an evaluation procedure to perform suitable message summarization by the server.

Referring to FIG. 10, in a step 1001, the server performs re-training for a summarization model which summarizes unread messages. The summarization model may be a program to summarize the unread messages. In some exemplary embodiments, the re-training learns characteristics of a chat document received from a second client apparatus. The re-training is performed so that better summarization may be peformed by finding out a suitable summarization model. The feedback from the second client apparatus may be based on the selection of a user of the second client apparatus.

In a step 1003, the server reviews the accuracy of current summarization. In a step 1005 the server compares the accuracy of a current summarization model with the accuracy of a previous summarization model. The accuracy of the summarization model indicates an accuracy for the performance of the summarization model.

When the accuracy of the current summarization model is better than the accuracy of the previous summarization model, in a step 1007, the server inputs a current summarization model into a summarization engine. The summarization engine may be an application operated by the server. In a step 1009, the server determines a new summarization engine in which the current summarization model is inputted.

When the server determines that the accuracy of the current summarization model is worse than the accuracy of the previous summarization model, in a step 1011, the server ignores the current summarization model. When the server ignores the current summarization model, the server maintains the previous summarization model.

FIG. 11 illustrates an example user interface in a client apparatus according to an exemplary embodiment of the present disclosure. As previously noted, this automated summarization system may run based on certain time setting that may trigger a client application to send a summarization request to a server. In attaching and providing a summary produced in a message application, the present disclosure may require no change in the habits of users when opening or reading messages that may cause inconvenience. Given that, there are some aspects which may require different implementation. The present disclosure considers that a summary does not always exist and not all unread messages may have been summarized when, for example, a client opens chat room. In this section, some relevant aspects may be considered.

In a case in which a summary is produced from a server, all unread messages may have been summarized. The first case is a basic case of a summarization system scheme when all unread messages have been summarized at the time a client opens a chat room. FIG. 11 illustrates an example user interaction scheme when opening a notification from message application. It is assumed in FIG. 11 that the summaries produced from unread messages have been stored in a server. When a client enters chat room, a pop-up window may automatically appear. This window consists of summaries in summary box and includes two options: OK and Cancel. An OK button may be selected by a user who is satisfied with the provided summary. If the user selects OK, then the application may present the messages and the pointer of messages may appear below the last message (or in this case, below the message n). Otherwise, if a client selects a cancel button, the pointer may appear normally in the message 1. A pop-up window may be an interface displayed on a display.

Therefore, FIG. 11 illustrates an example user interface displayed by a second client apparatus when all unread messages are summarized and when the server generates summarized data. A user interface displayed on the second client apparatus indicates that all of the unread messages were summarized when a user opens the a chat room or that a summarization system method is executed.

Referring to FIG. 11, in (a), the second client apparatus displays a user interface which indicates an alarm for the number of new messages and the number of buddies. In a step 1101, the second client apparatus recognizes the open of a chat room by a user. For example, the second client apparatus recognizes that an alarm from a message application is selected by the user.

When the second client apparatus recognizes that the chat room is opened by the user, the second client apparatus displays a pop-up window, for example a pop-up window indicated in portion (b). The pop-up window may include two options. The two options include a case which displays at least one summarized unread message and a case which does not displays unread messages. For example, the second client apparatus displays “yes” when the at least one summarized unread message is displayed and the second client apparatus displays “no” when the unread messages are displayed. Therefore, the second client apparatus can display summarized unread messages based on the selection of the user and can display unread messages which are not summarized. Herein, the unread messages, which are not summarized, are the same as the state of messages received from a first client apparatus by the server. For example, the second client apparatus can display an “OK” button in case of “yes” and can display a “Cancel” button in case of “no”. The user can select the “OK” or “Cancel” button displayed on the second client apparatus.

When a user selects the “OK” button in the second client apparatus, the second client apparatus displays a group of the summarized messages, for example such as indicated in portion (c). When the second client apparatus displays the group of the summarized message, a pointer of the messages is located at the last of a screen. For example, the pointer of the messages is located under message-n. A summarization result may indicate that the user has enough readability when “OK” is selected by the user.

When a user selects “Cancel” in the second client apparatus, the second client apparatus successively displays messages, which are not summarized, as shown for example in portion (d). Herein, the messages, which are not summarized, are successively indicated. In some exemplary embodiments messages are displayed in sequence by arranging the messages in sequence of time. A summarization result may indicate that the user does not have enough readability.

A summarization engine is trained and updated by enabling the second client apparatus to collecting information selected by the user. The server can generate summarized data having higher readability than a previous readability.

FIG. 12 illustrates a flow chart for displaying an example user interface in a client apparatus according to an exemplary embodiment of the present disclosure. FIG. 12 illustrates an example procedure to display a user interface which displays unread messages or summarized unread messages in a client apparatus. The client apparatus may be an electronic apparatus. For convenience of the following description, the client apparatus is indicated as an electronic apparatus.

Referring to FIG. 12, in a step 1201, the electronic apparatus displays an interface related to received messages. The interface indicates a user interface displayed on a display. The electronic apparatus can detect a first and a second input for the interface. For example, the interface may be displayed on the display of the electronic apparatus as a pop-up window. The interface includes “yes” button and “no” button. The interface is provided to enable a user to select a service.

In a step 1203, the electronic apparatus determines whether summarized data associated with messages is displayed. The electronic apparatus can detect a first input for the interface. The electronic apparatus can detect a second input for the interface. The first input indicates that a user selects the display of the summarized data. The second input indicates that the user does not select the display of the summarized data. For example, the electronic apparatus determines to display summarized data for unread messages by receiving the selection of the user through the interface or that displays unread messages without summarization. For example, the electronic apparatus successively displays the summarized unread messages when the summarization of the messages is selected as “yes” by the user. The electronic apparatus successively displays the messages which are not summarized when the summarization of the messages is selected as “no” by the user.

In a step 1205, the electronic apparatus displays the summarized data associated with the messages when the electronic apparatus detects the first input for the interface. For example, the electronic apparatus successively displays the group of the summarized unread messages. Herein a pointer is located at a lower end on a list for the group of the summarized messages when the summarized messages are displayed.

Otherwise, the electronic apparatus displays messages in a step 1207 when the electronic apparatus detects a second input for the interface. For example, the electronic apparatus successively displays non-summarized messages. Herein the non-summarized messages indicate messages which are not summarized. When the messages which are not summarized are displayed, a pointer is located at an upper end on the list of the messages.

FIG. 13 illustrates a flow chart of an example operation in a client apparatus for displaying a user interface in a client apparatus according to another exemplary embodiment of the present disclosure. FIG. 13 illustrates an operation procedure for displaying a user interface by a second client apparatus. For convenience of the following description, the second client apparatus is indicated as an electronic apparatus.

Referring to FIG. 13, in a step 1301, the electronic apparatus receives messages from a server. The messages are not read in the electronic apparatus by a user who uses the electronic apparatus.

In a step 1303, the electronic apparatus receives summarized data associated with messages after predetermined time is passed. The predetermined time is related to operating time of a timer in the electronic apparatus. The electronic apparatus determines whether the predetermined time is passed by comparing the passed time after operating the timer with a threshold value. Herein, a storage of the electronic apparatus stores summarized data and messages which are not summarized. For example, the determination of passed time indicating that a predetermined time of the electronic apparatus is passed may be determined when a time between a first time at which a user previously confirms or reads a message and a second time at which the interface associated with the message is displayed, is larger than the threshold value.

In a step 1305, the electronic apparatus displays an interface associated with the received messages. The interface indicates a user interface displayed on a display. The electronic apparatus can detect a first input and a second input for the interface. For example, the interface may be displayed on the display of the electronic apparatus as a pop-up window. The interface includes “yes” button and “no” button. The interface is provided to enable a user to select a service.

In a step 1307, the electronic apparatus determines whether summarized data associated with messages is displayed. The electronic apparatus can detect a first input for the interface. The electronic apparatus can detect a second input for the interface. The first input indicates that a user selects the display of the summarized data. The second input indicates that the user does not select the display of the summarized data. For example, the electronic apparatus determines to display summarized data for unread messages by receiving the selection of the user through the interface or that displays unread messages without summarization. For example, the electronic apparatus successively displays the summarized unread messages when the summarization of the messages is selected as “yes” by the user. The electronic apparatus successively displays the messages which are not summarized when the summarization of the messages is selected as “no” by the user.

In a step 1309, the electronic apparatus displays the summarized data associated with the messages when the electronic apparatus detects the first input for the interface. For example, the electronic apparatus successively displays the group of the summarized unread messages. Herein a pointer is located at a lower end on a list for the group of the summarized messages when the summarized messages are displayed.

The electronic apparatus displays messages in a step 1311 when the electronic apparatus detects a second input for the interface. For example, the electronic apparatus successively displays non-summarized messages. Herein the non-summarized messages indicate messages which are not summarized. When the messages which are not summarized are displayed, a pointer is located at an upper end on the list of the messages.

FIG. 14 illustrates an example user interface in a client device according to another exemplary embodiment of the present disclosure. FIG. 14 illustrates a user interface displayed on a display of a second client apparatus when all unread messages are not summarized though summarized data exists in a summarization box of a server. In this case, summaries exist in a server but all unread messages have not been summarized. The above figure shows incoming messages (message 1, 2, . . . , n) not yet read by the second client. In this scheme, timer has reached its threshold and sends a summarization request to the server (assuming that such messages can be summarized). Sometime after this, the second client receives two new messages (message n+1 and n+2) and then opens chat room. Unlike the first case where all messages have been summarized, in this case there are some messages (message n+1 and n+2) not yet summarized.

Text summary in this case may be similar to case 1. The second client receives new message n+2. N denotes a previous cycle of the timer and represents the number of message that has been summarized. It is assumed here that the summaries have been produced in server and the second client enters a chat room before all unread messages (message n+2) have been summarized. Then a pop-up window may appear including unread messages at n number. Two options of “OK” and “Cancel” as for case 1 may appear. Here, if Client selects OK, the instant messaging services may display messages of unread and unsummarized messages, or in this case message n+1 and n+2. Otherwise, if Client selects cancel, the pointer may appear normally in the first message.

Referring to FIG. 14, in portion (a), the second client apparatus displays a user interface which indicates a notification for the number of new messages and the number of buddies. Herein, the new messages indicate messages which are not read by a user of the second client apparatus. The second client apparatus transmits a summarization request to a server when a timer is arranged to a limit point (the messages are supposed to be summarized). After some time, the second client apparatus receives two new messages (message n+1 and n+2) and opens a chat room. Some messages (message n+1 and message n+2) are not summarized. Herein, the some messages are different from messages in a case 1 in which all messages are summarized. Herein, a text summarization method is similar with a text summarization method used for summarized unread messages displayed on a user interface illustrated in FIG. 11. The second client apparatus receives new message n+2. N indicates a previous cycle and the number of the summarized messages. Herein, the server generates the summarized data and receives new unread message (message n+2). In the case that a user opens a chat room in the second client apparatus before the server summarizes the new unread message. The second client apparatus shall be indicated as an electronic apparatus.

In a step 1401, the second client apparatus recognizes that the chat room is opened by a user. Herein the chat room shall be an application of the second client apparatus. For example, the opening of the chat room by the user indicates that a notification of the message application is selected by the user.

When the second client apparatus recognizes that the chat room is opened by the user, the second client apparatus displays a pop-up window such as shown in portion (b). Herein, the pop-up window includes two options. The two options include a case which displays at least one summarized unread message and a case which does not display unread messages. For example, the second client apparatus displays “yes” when the at least one summarized unread message is displayed and the second client apparatus displays “no” when the unread messages are displayed. Therefore, the second client apparatus can display summarized unread messages based on the selection of the user and can display unread messages which are not summarized. Herein, the unread messages, which are not summarized, are the same as the state of messages received from a first client apparatus by the server. For example, the second client apparatus can display an “OK” button in case of “yes” and can display a “Cancel” button in case of “no”. The user can select “OK” or “Cancel” button displayed on the second client apparatus.

When a user selects the “OK” button in the second client apparatus, the second client apparatus displays a group of the summarized messages and new received message (message n+2) such as shown in portion (c).

When a user selects “Cancel” in the second client apparatus, the second client apparatus successively displays messages, which are not summarized, such as shown in portion (d). Herein, the messages, which are not summarized, are successively indicated. In some exemplary embodiments, messages are displayed in sequence by arranging the messages in sequence of time.

The two options provided in the pop-up window may have some benefits. First, a client or user can select to read or not to read the messages. Second, a summary system can improve the summaries based on feedback from users with regard to the readability of the produced summaries. Third, when there is no summary in server, it may be due to unread messages which cannot be summarized based on the result of message validation system, the first calculation of timer failing to reach the threshold, or the client arranging a configuration of not activating application for summarization request. In this case, unread messages may be displayed normally in a client application.

FIG. 15 illustrates a flow chart for displaying of a user interface in a client apparatus according to another exemplary embodiment of the present disclosure. FIG. 15 illustrates an example procedure to display a user interface in a second client apparatus when a chat room service is initiated in a second client apparatus by a user of the second client apparatus before a server generates summarized data for new messages by receiving the new message from a first client apparatus. The second client apparatus may be an electronic apparatus. For convenience of following description, the second client apparatus is indicated as the electronic apparatus.

Referring to FIG. 15, in a step 1501 an electronic apparatus receives messages from a server. The messages are not read in the electronic apparatus by a user who uses the electronic apparatus.

In a step 1503, the electronic apparatus receives summarized data associated with messages after predetermined time is passed. The predetermined time is related to operating time of a timer in the electronic apparatus. The electronic apparatus determines whether the predetermined time is passed by comparing the passed time after operating the timer with a threshold value. Herein, a storage of the electronic apparatus stores summarized data and messages which are not summarized. For example, the determination of passed time indicating that a predetermined time of the electronic apparatus is passed may be determined when a different in time between a first time in which a user confirms or read a message lastly and a second time in which the interface associated with the message is displayed is larger than the threshold value.

In a step 1505, the electronic apparatus receives at least one other message. The at least one other message is not summarized by the server after the electronic apparatus receives summarized data associated with unread messages from the server.

In a step 1507, the electronic apparatus displays an interface associated with the received messages. The interface indicates a user interface displayed on a display. The electronic apparatus can detect a first input and a second input for the interface. For example, the interface shall be displayed on the display of the electronic apparatus as a pop-up window. The interface includes “yes” button and “no” button. The interface is provided to enable a user to select a service.

In a step 1509, the electronic apparatus determines whether the summarized data associated with the messages is displayed. The electronic apparatus can detect a first input for the interface. The electronic apparatus can detect a second input for the interface. The first input indicates that a user selects the display of the summarized data. The second input indicates that the user does not select the display of the summarized data. For example, the electronic apparatus determines to display summarized data for unread messages by receiving the selection of the user through the interface or to display unread messages without summarization. For example, the electronic apparatus successively displays the summarized unread messages and the at least one other message when the summarization of the messages is selected as “yes” by the user. The electronic apparatus successively displays the messages which are not summarized when the summarization of the messages is selected as “no” by the user.

In a step 1511, the electronic apparatus displays the summarized data associated with the messages and the at least one other message when the electronic apparatus detects the first input for the interface. For example, the electronic apparatus successively displays the group of the summarized unread messages and the at least one other message. Herein a pointer is located at a lower end on a list for the group of the summarized messages when the summarized messages are displayed.

Otherwise, the electronic apparatus displays messages and the at least one other message in a step 1513 when the electronic apparatus detects a second input for the interface. For example, the electronic apparatus successively displays non-summarized messages. Herein the non-summarized messages indicate messages which are not summarized. When the messages which are not summarized are displayed, a pointer is located at an upper end on the list of the messages.

FIG. 16 illustrates a flow chart for an example of keyword extraction according to an exemplary embodiment of the present disclosure.

Referring to FIG. 16, in a step 1601, a server receives messages from a first client apparatus. In a step 1603, the server analyzes a candidate keyword. The candidate keyword is extracted from messages received from the first client apparatus.

In a step 1605, a server scores the candidate keyword. Herein, the score of the candidate keyword is based on similarity between the sentence and the document. When the similarity is high, high scores are given to the candidate keyword. The other way, when the similarity is low, low scores are given to the candidate keyword.

In a step 1607, the server calculates the scores of the candidate keyword. In a step 1607, decomposition and message input are executed to generate a calculated value of each candidate keyword in a keyword validation process.

When the server determines that document validation is accurate, in a step 1611 the server determines that the document is valid. In a step 1613, the server generates summarized data for unread messages by performing a summarization procedure for the document.

When the server determines that the document validate is inaccurate, in a step 1615 the server determines the document is invalid. When the document is invalid, the score of the calculated keyword is lower than the threshold value.

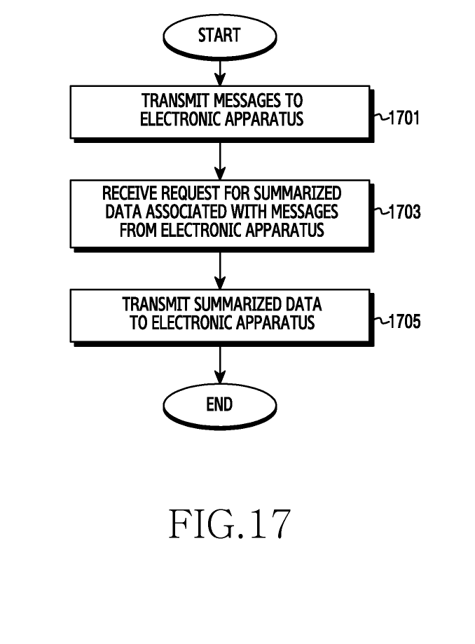

FIG. 17 illustrates a flow chart of operation in a server apparatus for transceiving a signal according to an exemplary embodiment of the present disclosure. FIG. 17 illustrates the operation of a server apparatus which transmits and receives signals.

Referring to FIG. 17, in a step 1701 the server transmits messages to an electronic apparatus. For example, the electronic apparatus shall be a client apparatus. The messages transmitted from the server to the electronic apparatus are received from other electronic apparatus. The server forwards the messages between the electronic apparatus and the other electronic apparatus. The server can generate summarized data associated with messages received from other electronic apparatus.

In a step 1703, the server receives a request for the summarized data associated with the messages from the electronic apparatus. The request for the summarized data is received when a difference between a time in which a user confirms a message from the electronic apparatus and a time in which the interface is displayed on the electronic apparatus is larger than a threshold value. The request for the summarized data can be received automatically when the interface is activated by the user.

In a step 1705, the server transmits the summarized data to the electronic apparatus. The server generates summarized data by analyzing messages received from other electronic apparatus and by evaluating the summarized data based on feedback data received from the electronic apparatus.

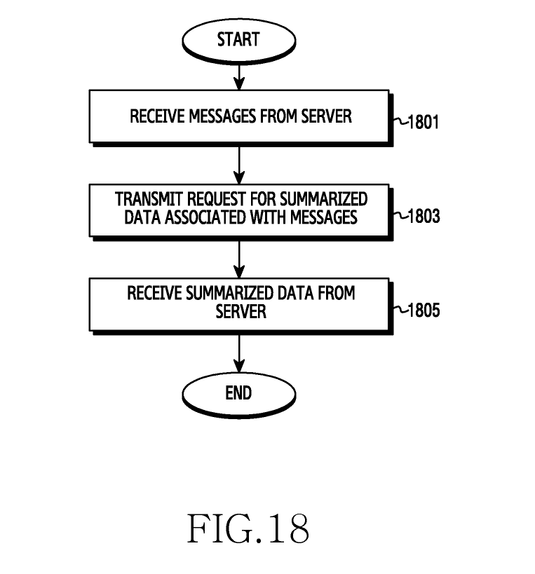

FIG. 18 illustrates a flow chart of operation in a client apparatus for transceiving a signal according to an exemplary embodiment of the present disclosure. FIG. 18 illustrates the operation of an electronic apparatus which transmits and receives signals.

Referring to FIG. 18, in a step 1801, the electronic apparatus receives messages from the server connected to the electronic apparatus. For example, the electronic apparatus may be a second client apparatus. The messages transmitted from the server to the electronic apparatus are received from other electronic apparatus.

In a step 1803, the electronic apparatus transmits a request for summarized data associated with the messages to the server. The request for the summarized data is received when a difference between a time in which a user confirms a message from the electronic apparatus and a time in which the interface is displayed on the electronic apparatus is larger than a threshold value. The request for the summarized data can be received automatically when the interface is activated by the user. The electronic apparatus determines the time in which the user confirms the message and the time, in which the interface is displayed, by using a timer. The interface is displayed on a display of the electronic apparatus.

In a step 1805, the electronic apparatus receives the summarized data from the server. The server generates summarized data by analyzing messages received from other electronic apparatus and by evaluating the summarized data based on feedback data received from the electronic apparatus.

According to exemplary embodiments of the present disclosure, because unstructured data is being used, some documents or messages may not be added to the summarization system, for example due to the quality of the summary itself. If it can be decided in an early stage whether a document is qualified to be summarized or not, it may be beneficial for the quality of the summary. One possible requirement before a summarization process is the ability to extracting keywords from particular documents (hereinafter referred to as document).

On exemplary approach to automatically extract keywords may focus on statistical evaluation of individual words oriented to the document. A popular method in this respect is TextRank. TextRank focuses on document orientation combining human language processing approach to identify part-of-speech (PoS) label combined with unsupervised learning, machine learning algorithms or statistic methods. TextRank may reach its best capacity when nouns and adjectives are selected as potential keywords, which are dependent on the collection of documents.

The well-known approach to extract keywords of unstructured documents such as chats is that of Rapid Keyword Extraction (RAKE). This approach focuses on word statistics, unsupervised, domain and language independent. With such advantages of RAKE, we can use and modify RAKE as basis for verification purpose (Summary Capacity Detection). In short, to verify whether a document can be summarized or not, it can be made based on the total of word scores that have been calculated and total of keywords extracted after completing keyword extraction process. If the totals of word scores and keyword scores exceed the specified threshold, we can conclude that document may to be summarized using summarization machine. Threshold for each process can vary subject to how the system learns previous process.

The incoming message in keyword decomposition may continue in a keyword validation process to produce the calculation value of each keyword. If the result of document validation is mistaken (or does not comply with the threshold), the document is not valid. If the document validation is correct, the document is valid and then enters summarization process.

The present disclosure has been illustrated and depicted with reference to exemplary embodiments. Individuals who are well-informed of this field or skilled in the art may understand that many revisions in terms of shapes and details can be made without changing the core and coverage of the present disclosure as indicated in the attached claims.

The exemplary embodiments should be construed for descriptive purpose only instead of limitations. In light of that, the coverage of the present disclosure is not defined by detailed elucidation but the attached claims and their equivalents, and any and all controversies in the coverage may be construed of being included in the present disclosure.

1. A method of operating an electronic apparatus, the method comprising:
displaying an interface associated with a plurality of messages received by the electronic apparatus;
displaying summarized data associated with the plurality of messages when a first input is detected at the interface; and
displaying the plurality of messages when a second input is detected at the interface.

2. The method of claim 1, further comprising:
receiving the plurality of messages from a server communicating with the electronic apparatus;
transmitting a request for the summarized data to the server; and
receiving the summarized data from the server.

3. The method of claim 2, wherein the request for the summarized data is transmitted when a time difference between a first time at which a user confirmed a message and a second time at which the interface is displayed is larger than a threshold value.

4. The method of claim 2, further comprising:
receiving at least one other message after receiving the summarized data;
displaying the interface;
displaying the summarized data and the at least one other message when the first input is detected at the interface; and
displaying the plurality of messages and the at least one other message when the second input is detected at the interface.

5. The method of claim 2, further comprising:
transmitting a request for the summarized data to the server when the interface is displayed.

6. The method of claim 2, further comprising:
transmitting feedback data associated with at least one from among the first input and the second input to the server.

7. The method of claim 6, wherein the summarized data is generated based on at least one from among data included in the plurality of messages and the feedback data by the server.

8. A method of operating a server apparatus, the method comprising:
transmitting a plurality of messages to an electronic apparatus;
receiving a request for summarized data associated with the plurality of messages from the electronic apparatus; and
transmitting the summarized data to the electronic apparatus.

9. The method of claim 8, further comprising:
determining whether the summarized data is capable of being generated based on the plurality of messages;
clustering the plurality of messages into a plurality of clusters when the summarized data is capable of being generated; and
generating the summarized data by summarizing the plurality of clusters.

10. The method of claim 8, further comprising:
receiving feedback data associated with the summarized data from the electronic apparatus; and
evaluating the summarized data based on the feedback data.

11. The method of claim 10, wherein the summarized data is generated based on at least one from among data included in the messages and the feedback data by the server.

12. The method of claim 11, further comprising:
generating the summarized data associated with the messages by comparing the accuracy of the summarized data and the accuracy of previous summarized data based on the feedback data.

13. An electronic apparatus, comprising:
a display configured to display an interface associated with a plurality of messages received by the electronic apparatus, to display summarized data associated with the plurality of messages when a first input is detected at the interface; and to display the plurality of messages when a second input is detected at the interface.

14. The electronic apparatus of claim 13, further comprising:
a transceiver configured to receive the messages from a server connected to the electronic apparatus, to transmit a request for the summarized data to the server, and to receive the summarized data from the server.

15. The electronic apparatus of claim 14, wherein the request for the summarized data is transmitted when a time difference between a first time at which a user confirms a message and a second time at which the interface is displayed is larger than a threshold value.

16. The electronic apparatus of claim 14, wherein the transceiver is configured to receive at least one other message after receiving the summarized data, and
wherein the display is further configured to display the interface; to display the summarized data and the at least one other message when the first input is detected at the interface; and to display the messages and the at least one other message when the second input is detected at the interface.

17. The electronic apparatus of claim 14, wherein the transceiver is further configured to transmit a request for the summarized data to the server when the interface is displayed.

18. The electronic apparatus of claim 14, wherein the transceiver is further configured to transmit feedback data associated with at least one from among the first input and the second input to the server.

19. The electronic apparatus of claim 14, wherein the summarized data is generated based on at least one from among data included in the plurality of messages and the feedback data by the server.

20. A server apparatus, the server apparatus comprising:
a transceiver configured transmit a plurality of messages to an electronic apparatus, to receive a request for summarized data associated with the plurality of messages from the electronic apparatus; and to transmit the summarized data to the electronic apparatus.

21. The server apparatus of claim 20, further comprising:
a controller configured to determine whether the summarized data is capable of being generated based on the plurality of messages; to cluster the plurality of messages into a plurality of clusters when the summarized data is capable of being generated; and to generate the summarized data by summarizing the plurality of clusters.

22. The server apparatus of claim 21, wherein the transceiver is further configured to receive feedback data associated with the summarized data from the electronic apparatus, and
wherein the controller is further configured to evaluate the summarized data based on the feedback data.

23. The server apparatus of claim 22, wherein the summarized data is generated based on at least one from among data included in the plurality of messages and the feedback data by the server.

24. The server apparatus of claim 23, wherein the controller is further configured to generate the summarized data by comparing the accuracy of the summarized data with the accuracy of previous summarized data based on the feedback data.

25. A method of controlling an electronic apparatus, the method comprising:
receiving an input from a user at a first time;
receiving a plurality of messages from a server at a second time;
determining a time difference between the first time and the second time;
if the time difference is greater than a predetermined threshold, requesting from the server summarized data associated with the plurality of messages; and
displaying at least one of the summarized data or the plurality of messages to the user.
